(19) United States
(12) Patent Application Publication
(10) Pub. No.: US 2007/0174258 A1
(43) Pub. Date: Jul. 26, 2007

(54) Targeted mobile device advertisements

(76) Inventors: Scott A. Jones, Carmel, IN (US); Brad Bostic, Carmel, IN (US)

Correspondence Address: STAAS & HALSEY LLP, SUITE 700, 1201 NEW YORK AVENUE, N.W., WASHINGTON, DC, 20005, US

(21) Appl. No.: 11/647,437

(22) Filed: Dec. 29, 2006

Related U.S. Application Data
(63) Continuation-in-part of application No. 11/336,928, filed on Jan. 23, 2006.
(60) Provisional application No. 60/807,428, filed on Jul. 14, 2006.
(60) Provisional application No. 60/821,484, filed on Aug. 4, 2006.

(51) Int. Cl. G06F 17/30

(52) U.S. Cl. 707/3

(57) ABSTRACT

Targeted advertisement is provided to mobile device users based on one or more keywords in words spoken by the mobile device users. The users may submit voice requests using mobile phones or other mobile networked devices, relevant keyword(s) are determined from the requests and corresponding advertisements and/or products associated with the keyword(s) are provided to the users while the users are waiting for responses to the requests.

### CROSS-REFERENCE TO RELATED APPLICATIONS

This application is related to and claims the benefit of U.S. Application Ser. No. 60/821,484, filed Aug. 4, 2006, inventor Scott A. Jones, et al., titled TARGETED CELL PHONE ADVERTISEMENTS and U.S. application Ser. No. 11/336,928, titled A SCALABLE SEARCH SYSTEM USING HUMAN SEARCHERS, inventor Scott A. Jones, filed Jan. 23, 2006, in the United States Patent and Trademark Office, the disclosure of both of which are incorporated herein by reference.

### BACKGROUND

1. Field

The present invention is directed to advertising and, more particularly, to providing advertisements targeted to voice queries submitted by users.

2. Description of the Related Art

As advertising continues to become a highly competitive market, technologies for disseminating information promoting goods, services, corporations and ideas using different media are being developed. For example, advertisements may be provided to users of the World Wide Web when the users are browsing the Internet to search for desired information and particular goods or services. Data oriented use of mobile devices for functions similar to those performed using personal computers has caused an interest in providing advertisments via wireless network. However, current advertising technologies are directed to mass advertisement and do not provide customized advertisements directed to interests particular to users or their needs.

In addition, advertising information provided by typical advertising solutions is often non-relevant to voice queries submitted by users. For example, when a user submits, “what is the best selling apple product?” as a query for a search, advertising information pertaining to products of the Apple Computer Company is often provided even though use of the keyword “apple” in the query may be meant to refer to the fruit.

The above-discussed problems related to mass advertising are further exacerbated for users of devices such as cellular phones because current search engines provide advertisements that are often irrelevant to what the users desire to know even after requiring mobile device users to input requests using the limited display capability and awkward input methods of cellular phones and such advertisements are often subscription based.

Although various advertising methods are known, there is no known way of delivering targeted advertising information via a wireless network.

### SUMMARY

A system and method are disclosed for linking an advertisement to correspond to one or more keywords and presenting the advertisement responsive to a voice query determined to contain at least one of the keywords by a human searcher.

The system and method include receiving a voice query from a mobile user and converting the voice query into text, extracting a keyword from the converted text and allowing a human searcher to select an advertisement for the keyword and providing the advertisement to the user.

A system and method is disclosed for associating advertisement data to one or more keywords or phrases, where the associating is based on relation of content of the advertisement data to a predefined category, usage or meaning of the keywords or phrases.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a system for linking advertisements to keywords and providing targeted mobile device advertising.

FIG. 2 is a flowchart illustrating association of advertisement data to keyword(s) and displaying selected advertisement data targeted to the keyword(s).

FIG. 3A is an illustration of an operation for selecting advertisement for a voice query to be provided to a user submitting the query.

FIG. 3B is an illustration of an operation for providing a coupon pertaining to an advertisement presented to a user.

FIG. 4 is a block diagram of illustrating selection of an advertisement in response to a voice query and sending a text message containing a coupon directed to offering(s) in the advertisement.

FIG. 5 is a relationship diagram illustrating correlation between qualified keyword and advertisements.

FIG. 6 is an illustration of presenting targeted advertisement to a user via a cellular phone or other wireless network (WiFi, WiMax, etc.).

FIG. 7 is a database relationship diagram illustrating correlation between advertisements and information of a particular user and a query submitted by the user.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

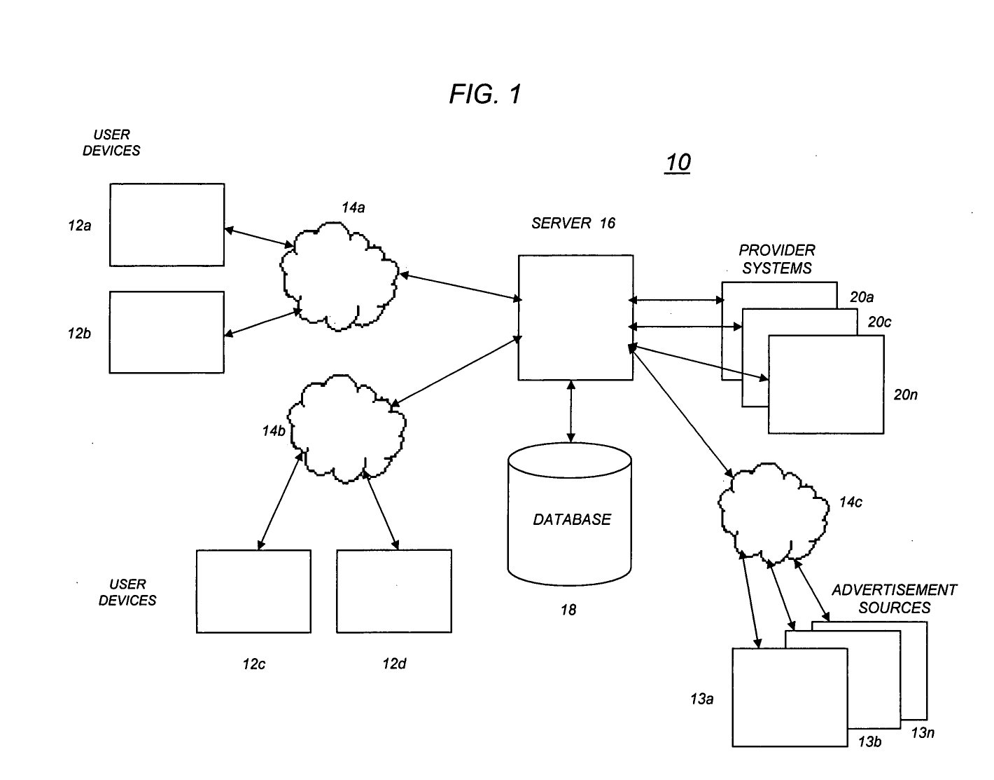

A system for targeted mobile device advertising is illustrated in FIG. 1. A request for information may be a voice or text query or keyword(s) submitted from a user (or information seeker) using a mobile device and may entail a fully-formed question, sentence, keyword or search phrase. A provider, a guide or paid searcher (PaidSearchers™) is a human searcher who has registered to handle requests, who may be a professional, an amateur and/or volunteer searcher. A requester (InfoSeekers™) is a user, a consumer or an entity submitting request seeking information, products, or services. An advertisement source is a system, an application program or any other source of advertisement information that is accessible using the Internet, public and private databases including data accumulated based on a knowledge base of the provider, etc., including text, image, multimedia, or any other electronic information. A coupon refers to information that indicates entitlement of a holder to some specified accommodation including a discount or rebate with respect to a product or service.

As shown in FIG. 1, system 10 receives voice requests or queries submitted by users or information seekers from user devices 12, delivers the requests to providers for processing and returns responses resulting from the processing by the providers to the users. The user devices 12 shown in FIG. 1 may be mobile phones, landline phones, specialized voice query terminals, voice-enabled PDA's (personal digital assistants), or any other source that allows a user to enter a query via speech entry or a Short Message Service (SMS) and communicate with server 16 via networks 14a and/or 14b. Although networks 14a and 14b are illustrated as connecting user devices 12 to the server 16, the system disclosed is not limited to any particular number of networks via which user devices may connect to the server 16. The user devices 12 may also be typical touch-tone telephones, two-way radios, wifi phones, cordless phones, portable media devices, or any communication device that allows the user to communicate with the server 16 via networks 14a and/or 14b. The communication system can include packet switched facilities, such as the Internet, circuit switched facilities, such as the public switched telephone network, radio based facilities, such as a wireless network, etc.

When the server 16 receives a voice request from any of the user devices 12, the server 16, determines which provider(s), registered with the system 10 to handle requests and currently available, actually matches the request. The providers using provider systems 20 may identify at least one category, subcategory, keyword, or area of interest pertaining to which the provider is willing to accept requests. For example, each available provider registered to handle requests pertaining to the category “health” may be identified and ranked against other providers registered for the category according to prior success in responding to requests to assign the request to top ranked available provider(s) within the category. Various types of conditions may be applied to determine provider(s) matching a request for optimizing responses from the provider(s). Further, any criteria discussed in U.S. patent application Ser. No. 11/336,928 may be used.

The queries from the user devices 12 may be stored in a database 18 and conventionally converted into digital text queries. The system 10 may transcribe voice queries submitted from user devices 12 into text, possibly by interaction with other systems, or it may perform the task locally. The system 10 may perform speech to text conversion using either speech transcription using human transcribers or using conventional speech-to-text processing, also known as automatic speech recognition (ASR). The voice queries may originate from a user's telephone and may be handled initially via automated attendant speech prompt type processing (or alternatively, via an interactive speech response or IVR system) to obtain the user's query. Further, the voice queries or speech recording received from the user devices 12 may also be delivered to provider systems 20 with the converted text. Users may also submit text queries to the system 10 by sending short messages containing the queries via the user devices 12.

The system 10 may keep track of the port from which a call originated as well as the telephone number of the caller, and assign user identifier to the user device 12 on this port for a particular session. The system 10 may prompt a user to speak the query, or voice queries may also originate from another source such as a speech query service requestor (SQSR) rather than directly from the user, such as a private or public information provider. For example, a voice or speech query may be initially processed by a public library telephone system and switched to the server 16. Sources such as the SQSR transmitting voice queries to the system 10 may communicate with the server 16 via a variety of mechanisms including an IP-based socket address or via a Microsoft NET service, making translation services widely available via the Internet to any application that wishes to use them.

The speech query may physically arrive at the system 10 via a variety of input mechanisms, including time-division multiplexed lines, voice over IP (VOIP) packets from an Internet connection, etc., and may arrive as a stream or packet or series of packets. Further, the voice queries may be submitted to the system 10 from a commercial site, such as a grocery store ordering system where a user orders food and inquires about recipes for a special after-dinner dessert, which may initially process a speech query and pass the query along to the server 16. The text entry features of cellular telephones may also be used to enter a query in digital text form allowing users to submit queries textually from telephones.

In response to receipt of a voice query, the system 10 may provide one or more advertisements to a user while the search is being processed. The advertisement may relate to the query (or to the keywords of the query) and include visual and audio information as appropriate for the user's device and for the source of the query. This information may include not only advertisements, but also information such as video, graphics, music, games, web links, etc. that will interact with and be displayed to the user. The information or products provided may serve as a source of revenue, for example through advertising. Further, if the user views an advertisement, or clicks on a link, or purchases a product or orders a service offered (sometimes referred to as “conversion”) related to an advertisement while awaiting results of a search, the database 18 may be updated to reflect additional ad revenue with a credit of points and/or compensation, if appropriate, to the provider (or searcher).

An advertisement presented to a user may be based on a weight associated with the advertisement in accordance with a single or combined factors such as advertiser contract commitments, bidding price of advertisers, popularity with users, keyword mapping to advertisements, statistical usage (e.g. least recently presented), user demographics, provider choice of advertisement, geographical location of the user and/or provider, etc. For example, a voice query pertaining to a schedule of performances at The Kennedy Center for the Performing Arts in Washington, D.C. from a user who indicates being a resident of New York or whose telephone number corresponds to a New York number, may trigger one or more advertisements related to Broadway shows in New York to be presented to the user, who might respond by purchasing tickets.

Users of the system 10 may be provided with an option of submitting a request directly to resource(s) identified in the database 18 based on keywords or categories extracted from the request, when a user opts to conduct a search without necessarily invoking assistance from a provider. For example, a user searching for a location of a particular restaurant in Carmel, Ind., may be presented with advertisements pertaining to popular attractions in Carmel while the location of the particular restaurant is being searched.

When a voice query from one of the user devices 12 is received by the system 10, for example, for a search without requesting assistance from a provider (or guide), the query is transcribed and passed to one or more search engines or resources, and advertisements associated with the query may be selected based on keyword histograms in the database 18 that “best fit” the query and as appropriate for the user telephone number. For example, when a user requests information pertaining to “restaurants in Indiana” and data records in the database 18 indicates that a particular seafood restaurant advertisement has been presented to similar previous queries, the seafood restaurant advertisement may be presented to the user. The user telephone number or other geographic data such as GPS coordinates may also be used to select from restaurant advertisements in Indiana to provide one in or near the designated geographic location. Geographic information may also be requested by the system during the call, usually during the beginning of the session. The request from the system (or guide) may be of the form of voice or text. The response by the user may also be in the form of voice, text, or touchtone entry. The guide may ask the user or an automated voice may ask the user for location information. The location information may be a zip code, a street number, a street intersection, a point of interest, latitude and longitude coordinates, an area code, or any other form of location information. This location information, once gathered by the system, may then be stored. Keywords may be linked to guides and/or advertisements that are tied to a specific geographic area that has a well-defined boundary. Alternatively, a guide or advertisement may be chosen based on the “closest” guide or advertiser to the user who is making the query.

The database 18 may maintain information about provider (or human searchers), requests submitted from the user devices 12, results generated by the providers in response to the requests, advertisements presented to the users while corresponding requests are being processed by the system 10 including advertisements previously presented for requests pertaining to similar subject matter. For example, the database 18 may maintain a record of advertisements presented in response to queries containing particular keyword(s) and whether users interacted with the advertisements.

The database 18 may also maintain information associated with a number of advertisements presented while voice queries are being processed by the system 10, a number of times a particular advertisement is presented in association with one or more keywords, advertisements hand-selected by providers, etc. For example, the server 16 may compute the number of times an advertisement has been presented, the length of time a user (or requester) viewed an advertisement, whether the user “clicked through” or accessed the advertisement, whether the user bought products or requested services from an advertiser's website referred to in the advertisement (this information may be delivered back to the server 16 from the advertiser), etc.

Although FIG. 1 illustrates the database 18 as a separate component of the system 10, the database 18 may be integrated with the server 16. Further, the records maintained in the database 18 may be stored in any conventional manner, including in a Network Attached Storage (NAS), a Storage Area Network (SAN), etc. using any conventional or proprietary database software such as DB2, Informix, Microsoft SQL, MySQL, Oracle, etc., and may also be a distributed database on more than one server.

Results of searches and advertisements may be conveyed to users over a real-time VOIP or circuit-switched connection between the user and the provider, via a text-messaging system such as, SMS, etc., and may be in the form of text, graphics, URLs, audio, or video. The results may also be an audio/video message recorded by a provider and played to the user including a reference to sources where the user may obtain results and may be digital text that has been conventionally converted into audio and played to the user. Text results may be played to the user using speech synthesis or speech reading, as is done with audiobooks where the text may be read aloud in real-time by the same (or different) resources (e.g. the transcribers described above) that are being used to transcribe speech to text.

The system 10 includes advertisement sources 13 that may provide advertisement data to the server 16. For example, businesses may provide advertisements selected for particular products or services offered by the businesses. However, the disclosed system is not limited to advertisements provided from advertisement sources 13. For example, a provider may use a database accessible only by the provider such as a database of advertisements previously gathered by the provider in relation to a product, or from databases that require payment for access or even information available to the provider in non-electronic form, may be delivered to the user devices 12, etc.

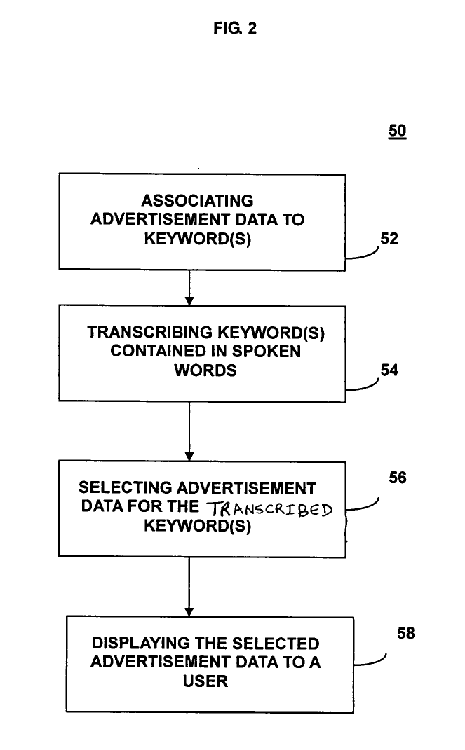

An exemplary process 50 for targeted advertising is illustrated in FIG. 2. As shown in FIG. 2, process 50 begins with associating 52 advertisement data to one or more keywords. As previously discussed, a request may be any type of inquiry or keyword(s) for which a user (i.e., infoseeker™) is seeking specific or general information which may be associated with corresponding advertisement data. For example, advertisement data pertaining to the Indiana Pacers may be associated with the keywords “Reggie Miller.”

Subsequent to associating 52 the advertisement data to the keyword(s), process 50 continues by transcribing 54 keyword(s) contained in spoken words of a user or information seeker submitting a request to the system 10. As mentioned above, the voice queries may be processed locally at the system 10 (FIG. 1) to convert the queries from digitized speech into text or, may alternatively be processed by a remote system. For example, the digitized speech may be transcribed by human transcribers that listen to the speech (e.g., via headphones or speakers), transcribe the information by typing the text and forward the text to the server 16.

The speech query may be divided into a stream of packets and passed to the transcriber, without interruption, as it is being spoken by a user, thereby allowing for reduced latency in the system 10 (FIG. 1). Preferably, there are many more transcribers available in the system 10 than there are instantaneous queries so that delays are not induced into the system. In the case of an overflow of queries, a form of flow control may be utilized by telling some callers that they must hold on the line for an available transcriber (which might be described to the caller as holding for an operator or agent). Further, the system 10 (FIG. 1) may feed continuous sequential speech phrases from various and different sources (e.g. users) to any given transcriber. Hence, the transcriber is sequentially transcribing, in rapid succession, speech messages from various speakers and creating separate text packets that are associated with each speech message. Likewise, the speech “packets”, which might be fixed length segments or variable length segments divided at intervals between words, from one speaker may be transcribed by multiple transcribers simultaneously or nearly simultaneously. The transcribed text can be pieced back together into the same order as the speech “packets” were dissected from the original speech message. Hence, a long voice recording could be transcribed in a much shorter period of time because the transcription job is broken down into several pieces that are handled by multiple human transcribers.

After transcribing 54 keyword(s), process 50 continues to selecting 56 advertisement data for the transcribed keyword(s). For example, advertisements associated with iPods may be selected for voice queries pertaining to apple products while advertisements associated with a particular type of the fruit apple may be selected for a query requesting information related to apple pie recipes.

Subsequent to selecting 56, process 50 continues presenting, playing or displaying 58 the selected advertisement data to a user. The advertisement data may be displayed while a user is waiting for results of a search. It is also possible to delay displaying of advertisement data until an appropriate provider or searcher is chosen to handle a query. In this case, the provider may have the option to choose the advertisement that is sent to a user who submitted the query, which might be based upon the query and/or keywords and/or the provider's assessment of which advertisement to send. This advertisement choice may be accomplished by selecting from advertisement(s) predefined by a provider chosen to handle the query.

The advertisement data may be in a variety of formats and advertisement data may be displayed via mobile devices using various communication standards such as WAP enabling Internet communications and telephony services.

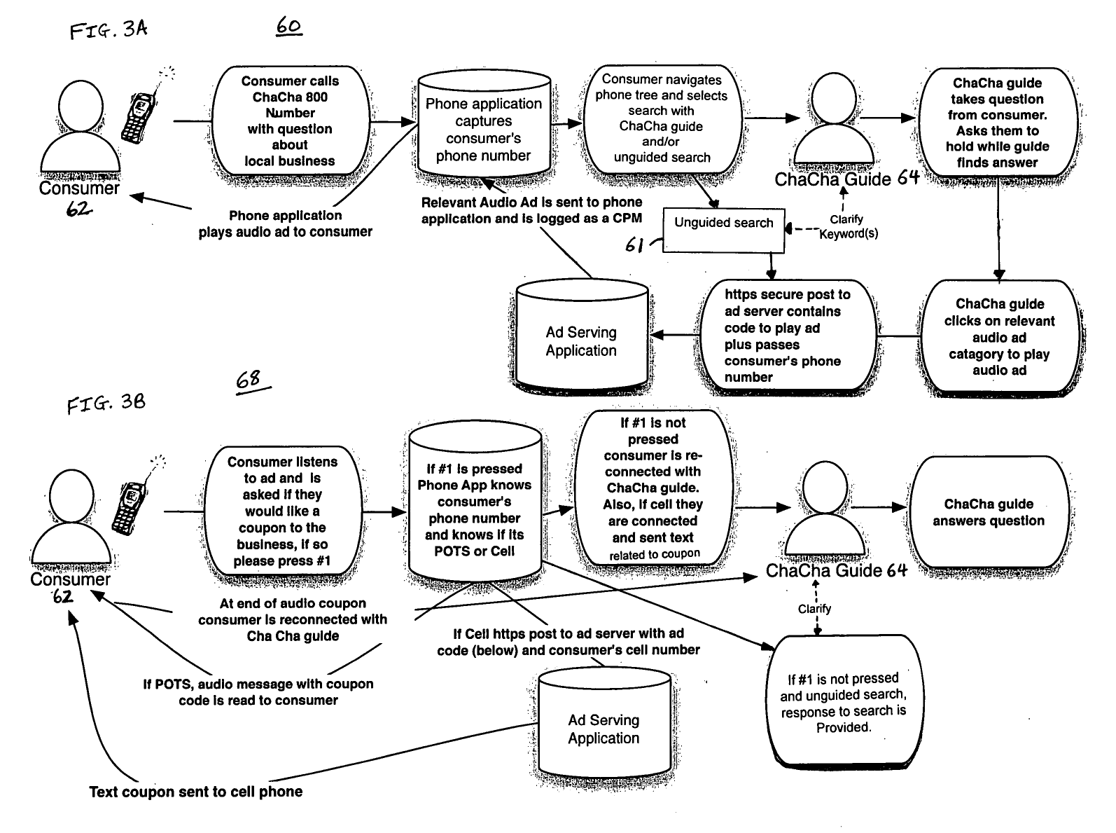

FIG. 3A illustrates a process 60 for presenting targeted mobile device (or telephone) advertising to a consumer. As shown in FIG. 3A, a consumer 62 places a call using a designated phone number for services offered by the system 10 (FIG. 1) and the phone application captures a phone number of the consumer. For example, the consumer 62 calls an 800 number with a query about a business in a particular locality and process 60 captures subscriber identity information such as a phone number of the consumer. Optionally, an advertisement may be presented to the consumer 62 after the initial call based on the telephone number of the caller. As mentioned above, the system 10 (FIG. 1) provides search options including an option for searching with assistance from a guide, provider or ChaCha guide 64, or an option for unguided search 61. For example, a consumer knowledgeable in a particular subject matter may request to conduct an unguided search, while opting for a guide assistance in other subject matters.

When consumer 62 selects a search with assistance from a ChaCha guide 64, the ChaCha guide 64 accepts the question or query from the consumer 62 and asks the consumer 62 to hold while the ChaCha guide 64 finds an answer or result in response to the question. While the consumer 62 is placed on hold, the ChaCha guide 64 selects or clicks on relevant advertisement category to be played to the consumer 62 waiting to receive the answer generated by the ChaCha guide 64 and/or a video advertisement to be displayed to the requester if his mobile device has image display capabilities.

When the ChaCha guide 64 selects the relevant advertisement category to be played, a code identifying the selected advertisement category and the network address of the consumer 62 is passed to an advertisement serving application to send the advertisement to the network address of the consumer 62. For example, a secure transmission protocol such as an https post containing a code identifying an advertisement and a consumer's phone number is provided using an advertisement serving application. Further, subsequent to sending the advertisement to the consumer's 62 mobile device, the advertisement may be logged as a cost per thousand (CPM) for calculating relative cost of the advertisement provided.

When the consumer 62 opts to conduct an unguided search 61, the question input by the consumer 62 may be submitted to resource(s) used by guides registered for handling requests pertaining to subject matter of the question, resource(s) selected by system administrator(s) or highly expert searcher(s) selected by the system administrator(s), etc. The consumer 62 opting to conduct an unguided search may also be provided with information stored in the database 18 (FIG. 1) including responses to previous requests, data gathered by guide(s) for responding to requests, etc., which may be utilized to produce automated results in response to the unguided search 61. As illustrated in FIG. 3A, the ChaCha guide 64 may be consulted to clarify keyword(s) contained in the question submitted by the consumer 62 who opted to conduct the unguided search 61.

The consumer 62 is placed on hold, while automated results are complied in response to the unguided search 61, and the system 10 (FIG. 1) may select the relevant advertisement category to be played. A code identifying the system selected advertisement category and the network address of the consumer 62 is passed to an advertisement serving application to send the advertisement to the network address of the consumer 62. For example, as discussed above, a secure transmission protocol such as an https post containing a code identifying an advertisement and a consumer's phone number is provided using an advertisement serving application. Optionally, the ChaCha guide 64 when clarifying keyword(s) contained in the question for the unguided search 61 may select an advertisement category to be played to the consumer 62 who is waiting to receive the automated result.

Although FIG. 3A illustrates the ChaCha guide 64 selecting an audio advertisement targeted to the question or query from the consumer 62, the process 60 is not limited to any particular type of advertisement. For example, a consumer may be provided with web links directing the consumer to a URL of a particular manufacturer or any other form of data capable of being transmitted and displayed via a cellular phone or other mobile device (PDA, WiFi PMP, etc).

FIG. 3B illustrates process 68 for providing a coupon pertaining to an advertisement presented to a user. As illustrated in FIG. 3B, the consumer 62 listens to or sees an advertisement and is asked if the consumer 62 would like to receive a coupon to a business identified in the advertisement. The consumer 62 is requested to press ‘1’, for example, if the consumer would like the coupon. If the consumer 62 presses ‘1’ the process 68 determines whether the cell phone of the consumer 62 is a POTS or a cell phone service, where process 68 triggers an https post containing a code identifying an advertisement and a consumer's phone number to be sent to the advertisement serving application for providing a text message containing information of the coupon to the cell phone of the consumer 62. After the text message is sent to the consumer 62, the consumer 62 is connected to the ChaCha guide 64 when a search with assistance of a guide has been requested. On the other hand, if the consumer 62 is using a POTS service or another service that does not have data service capability, an audio message with information of the coupon may be read or played to the consumer 62.

When determining that the consumer 62 has not selected to receive the coupon in process 68 by pressing ‘1’ and has requested a search with assistance of the ChaCha guide 64, the consumer 62 is reconnected to the ChaCha guide 64. When the consumer 62 has selected an unguided search 61 (FIG. 3A) and does not select to receive the coupon in process 68 by pressing ‘1’, the consumer is provided with a response to the search. As illustrated in FIG. 3B, the ChaCha guide 64 may be consulted to clarify selection of the consumer 62 pertaining to the advertisement and/or coupon provided.

The ChaCha guide 64 may use various types of tools to perform a search of publicly or privately available information to produce result(s) in response to the question or query submitted by consumer 62. For example, the guide may use tools such as a browser to access public databases via searches over the World Wide Web, private databases that may be accessible only by the provider such as a database of information previously gathered by the provider, results stored in the database 18 (FIG. 1) based on previous requests, or from databases that require payment for access or even information available to the provider in non-electronic form, such as a book on the provider's bookshelf, test results from a personal experiment, knowledge base of the provider, etc. In addition, the provider may submit the request or some version of the request to an automated search tool such as Ask.com®, etc, or any other similar system able to respond to questions submitted in natural language. Alternatively, the ChaCha guide 64 may copy the request, place the request into the search field of a search page for a particular search tool, for example, Yahoo®, and transmit the request to the search engine(s) automatically.

Further, processes 60 and/or 68 may determine a length of time during which the consumer 62 is communicating with the ChaCha guide 64 and provide an indication to the ChaCha guide 64 to send an advertisement to the consumer 62. For example, the guide may provide a voice snippet to the consumer while the guide is executing operations to service the consumer.

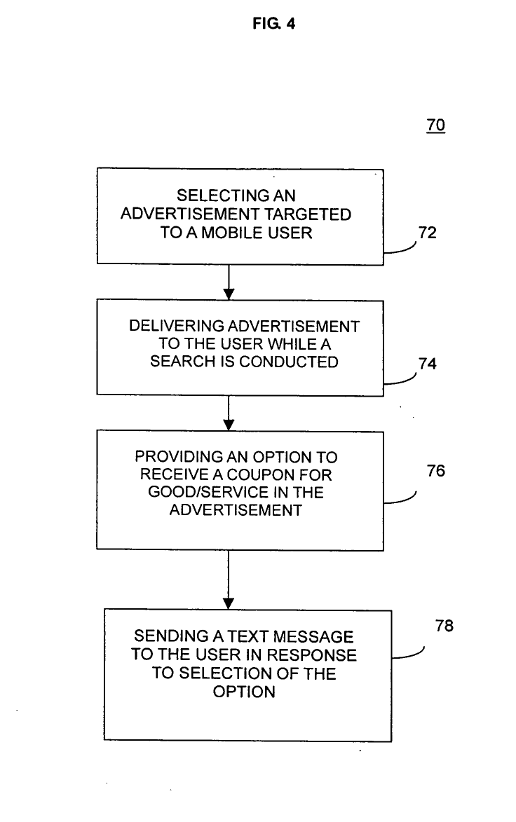

FIG. 4 illustrates process 70 for sending a text message in relation to an advertisement targeting a mobile user. As shown in FIG. 4, process 70 begins by selecting 72 an advertisement targeted to a mobile user. As mentioned above, the advertisement may be selected 72 by a provider or guide, or selected automatically by the system 10 (FIG. 1) based on a histogram that indicates classification or category of keywords or phrases identified by the system 10. The database 18 (FIG. 1) may maintain a histogram of usage for multiple meanings and/or forms of keyword(s) or phrase(s) which may be used to prompt a user (or consumer) or provider to qualify or clarify keyword(s) or phrase(s) having multiple meanings or forms when formulating a search query and an advertisement may be selected based on the qualified meaning of the keyword(s) or phrase(s). In addition, the system 10 may classify or categorize keywords and/or phrases based on information from external sources such as Internet directories (e.g., DMOZ), online dictionaries and/or encyclopedias (e.g., Webopedia, Wikipedia, etc.) or other similar sources. For example, a user (or provider) may be prompted to qualify keyword(s) contained in a query based on taxonomy utilized by DMOZ and an advertisement may be provided to the user based on meaning obtained from such qualification.

After selecting 72 the advertisement, process 70 moves to delivering 74 the advertisement to the user while a search is conducted. For example, while a provider is conducting a search to locate information responsive to a user's query pertaining to “dell computers”, one or more advertisements specific to discounted Dell products may be delivered to the user.

Subsequent to delivering 74 the advertisement, the process 70 moves to providing 76 an option to receive a coupon for the goods/services indicated in the advertisement. Using the same example in the previous discussion, if a user interacts with the advertisement pertaining to the specific discounted Dell products, an option to receive a coupon for the products may be provided to the user (see also FIG. 3B). In the case of electronic merchandise (eg. MP3 downloads) a product may be delivered in addition to an advertisement. For example the advertisement may contain video or audio ‘clips’ ad the consumer may elect to purchase the full-length product, which is then supplied to him.

When a user selects the option provided 76 for receiving a coupon, process 70 moves to sending 78 a text message which may be sent to the user using, for example, Short Message Service (SMS) or other similar service. For example, a coupon for a 15% discount at a particular restaurant may be sent to a user's cell phone in response to a voice query pertaining to the restaurant or other similar restaurants. When the mobile user device has image display capability, an image of a coupon may be sent.

Alternatively, an advertisement may be chosen randomly and sent to a user's cell phone. For example, advertisement of particular items may be presented to a user based on factors that may not be associated with the query of the requestor such as particular discounted items, new products, etc. This advertisement choice may be accomplished by enabling a provider to predefine which advertisement(s) to be presented to a requestor that is sent to that provider for a particular keyword.

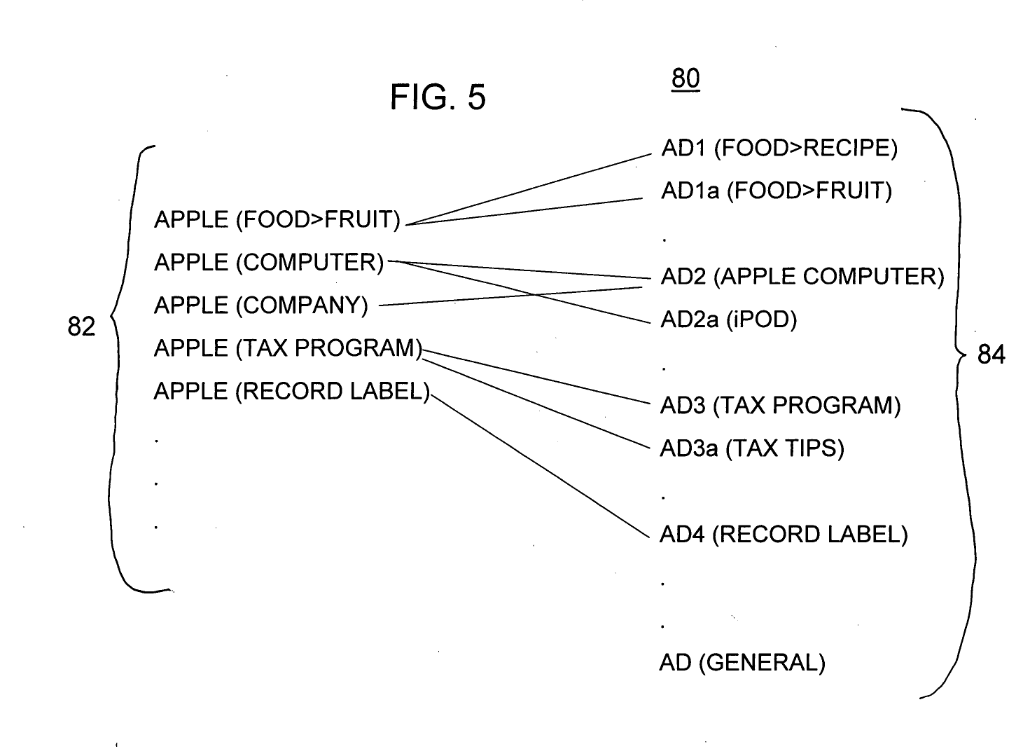

FIG. 5 is a simplified example of a relationship 80 illustrating association of qualified keywords 82 with advertisements 84. For example, when a search query containing the keyword “apple” is qualified to mean the fruit, an advertisement pertaining to food recipe and/or the fruit may be presented, while an advertisement pertaining to the tax program and/or tax tips are provided when the keyword “apple” in the query is qualified to mean the tax program.

Any qualified keyword maintained in the database 18 (FIG. 1) may be mapped to advertisement information for presenting one or more targeted advertisement(s) to a user (or requestor) submitting a voice query containing the qualified keyword. For example, upon receipt of a query from a requester via a cell phone 12a (FIG. 1), for example, the server 16 may provide advertisement(s) to the requestor for viewing while a search is being processed by the system 10. As mentioned above, the advertisement information may be related to the query (or to the keywords of the query and/or the location of the telephone), may include visual, audio and/or interactive information as appropriate for the user's device and for the source of the query and can include not only advertisements, but also information such as video, music, games, web links, etc. that will interact with and display data to the requestor while the search is being performed.

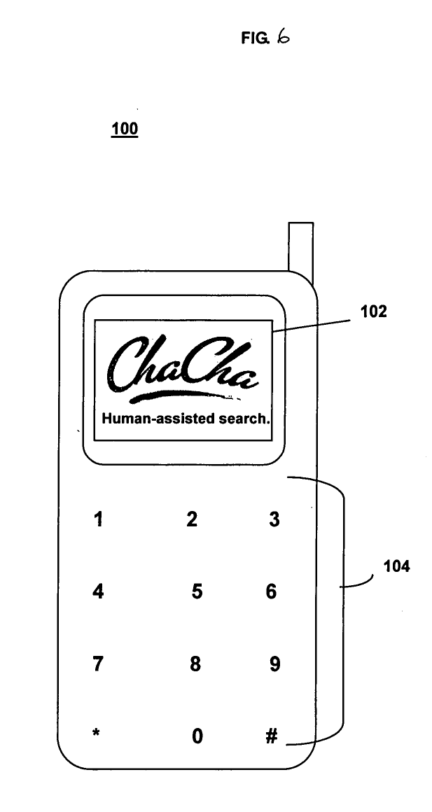

FIG. 6 illustrates an exemplary advertisement displayed via a cell phone 100. As shown in FIG. 6, the cell phone 100 includes selection keys 104 and an advertisement frame 102. The selection keys 104 detects a selection made by a user of the cell phone 100 and may be similar to conventional keys of portable devices. The advertisement frame 102 may display an advertisement related to a query submitted using the cell phone 100 or other image capable mobile device. For example, as illustrated in FIG. 6, an advertisement pertaining to a human assisted search technology may be displayed in the advertisement frame 102 in response to receipt of a voice query related thereto. On the other hand, advertisements displayed in the frame 102 may be provider selected real-time advertisements. Advertisers may also sign-up for keyword(s) so that their advertisements only display when the keyword(s) is a target of the query. This, for example, prevents wasteful display of advertisement information that is incorrectly targeted.

As mentioned above, advertisements provided via the advertisement frame 102 may include video, music, games, web links, etc. Alternatively, information provided in the advertisement frame 102 may be chosen by the server 16 (FIG. 1), for example, the server 16 may select information to be supplied to the advertisement frame 102 based on a time of day, an estimated time for completion of a search, etc. In any event, being able to link an advertisement to a particular keyword is extremely valuable to advertisers, particularly when the keyword is qualified as per the example above regarding the word “apple” which might have multiple meanings such as “computer company” or “fruit” or “tax program.”

Income from advertisements may be based on conventional measures, such as person-minutes that an advertisement was heard, partially or completely with repetition of advertisements not counted or counted less, responses to ads based on selection input through the selection keys 104. For example, options for interacting with advertisements may be provided via the cell phone 100 that say “press ‘1’ if you want to hear more about this advertisement now, press ‘2’ if you want to hear more about this advertisement after receiving your search query results, press ‘3’ if you want us to send you a voice mail message about a service/product included in this advertisement. However, the disclosed system and method are not limited to having a user interact with the advertisement in a particular way. For example, a sponsor of the advertisement may credit the source that delivered the advertisement in the case where an advertisement that provides a phone number to call may be tracked by the system in such a way that the calling number is tracked for the advertisement and for the sponsor's called number (i.e., compensate the system because the advertisement has caused the caller to actually call the number that was mentioned in the advertisement). Further, a user may be transferred directly to a particular business if the user presses a key or button during an advertisement.

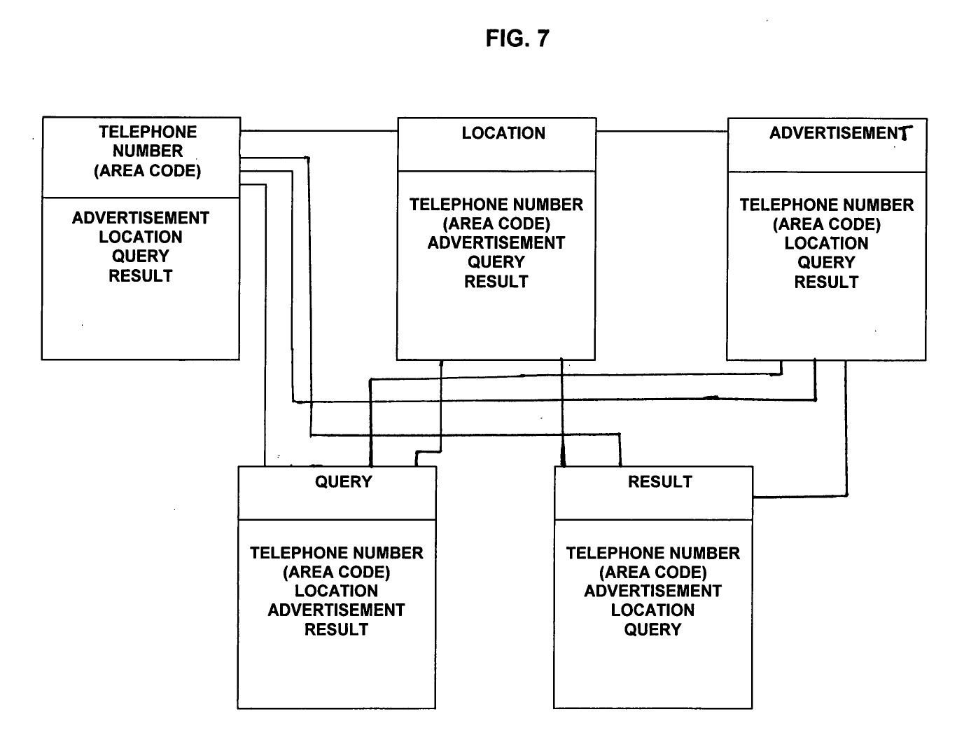

FIG. 7 illustrates a database relationship between a telephone number, a location, an advertisement, a query and a result. As shown in FIG. 7, a telephone number of a user submitting a voice query may be associated with an advertisement, a location, a query and a result. For example, when a voice query is received from a mobile phone of a user, a particular advertisement may be selected for display to the user based on a telephone number of the mobile phone used by the user. Using the same example, the advertisement may be selected by determining a location of the user based on an area code of the mobile phone or other subscriber identity information associated with the mobile phone and/or the user.

Accordingly, advertisements are sent to users based on keyword(s) in words spoken by the users or as determined by providers. In the preferred embodiment, the words spoken by the cell phone user is a search request, so it is known that the cell phone user is interested in information related to the keyword. The words spoken by the cell phone user are converted to text, either automatically, by human transcription, or by a combination of the two. Keyword(s) or one or more categories of keyword(s) in the transcribed text are identified and used to select one or more advertisements. The advertisements typically include audio and may also or alternatively include video, text, or still or animated graphics.

For mobile devices such as cell telephones with global position determination capability, location of a user may also be captured and used for determining an initial advertisement and for narrowing a range of advertisements that may be presented to the caller.

The system and method disclosed provides targeted advertising to cellular platforms using voice recognition by identifying a keyword in a spoken phrase, looking up the keyword in an index having corresponding advertising and providing the advertising to cellular subscribers.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope thereof. It will further be understood that the phrase “at least one of A, B and C” may be used herein as an alternative expression that means “one or more of A, B and C.”

What is claimed is:

1. A method of targeted advertising, comprising:
linking an advertisement to correspond to one or more keywords; and
presenting the advertisement responsive to a voice query determined to contain said one or more keywords by a human searcher.

2. The method according to claim 1, comprising:
converting the voice query to text using voice recognition.

3. The method according to claim 1, wherein the voice query is transcribed by human transcribers.

4. The method according to claim 1, wherein a user submitting the voice query interacts with the advertisement while the human searcher executes a search responsive to the voice query.

5. The method according to claim 1, wherein the advertisement is presented prior to the human searcher executing a search responsive to the voice query.

6. The method according to claim 1, wherein the human searcher qualifies a meaning of said one or more keywords by communicating with a user submitting the voice query.

7. The method according to claim 1, wherein the advertisement is selected based on association with previous queries directed to context matching that of the voice query.

8. The method according to claim 1, wherein human searchers registered for handling searches pertaining to a subject matter of the voice query pre-select the advertisement.

9. The method according to claim 1, wherein the human searcher selects the advertisement based on a phone number or other passive data of a user submitting the voice query.

10. The method according to claim 1, comprising:
determining a period of time during which the advertisement is presented; and
providing a voice or video snippet based on a review of the length of time by the human searcher.

11. The method according to claim 1, wherein coupon data related to content of the advertisement is provided in response to a selection of a user presented with the advertisement.

12. The method according to claim 11, wherein the coupon data is provided using SMS.

13. A method, comprising:
associating an advertisement with one or more keywords or phrases based on content of the advertisement and a predefined category corresponding to said keywords or phrases; and
providing the advertisement responsive to a voice query containing said one or more of the keywords or phrases.

14. A method, comprising:
receiving a voice query from a mobile user and converting the voice query into text;
extracting a keyword(s) from the converted text; and
enabling a human searcher to select an advertisement using the keyword(s) and providing the advertisement to the mobile user.

15. The method according to claim 14, wherein the keyword has more than one meaning and a meaning thereof as used in the voice query is determined based on prior search related uses of the keyword.

16. The method according to claim 14, wherein the selected advertisement is directed to a subject matter of the voice query.

17. A targeted advertising system, comprising:
a storage unit storing an advertisement in relation to one or more keywords; and
a display unit displaying the advertisement responsive to a voice query determined to contain one or more keywords by a human searcher.

18. A method for targeted advertising, comprising:
associating advertisement data to one or more keywords or phrases; said associating being based on relation of content of the advertisement data to a category, usage or meaning of the keywords or phrases;
transcribing a keyword or a phrase contained in spoken words including a voice query submitted, said transcribing executed based on voice recognition or human transcription;
analyzing the transcribed keyword or phrase including determining weight of the keyword over other keywords;
selecting an advertisement for the keyword or phrase contained in the spoken words based on said associating, said selecting being executed by a human searcher handling the voice query; and
providing the selected advertisement via a cell phone or other networked mobile device.

19. A method of targeted advertising, comprising:
determining an advertisement matching one or more keywords of a voice query based on a selection by a human searcher; and
sending the advertisement including a coupon for goods and/or services of a seller indicated in the advertisement to a mobile device via which the voice query is submitted.

20. A method, comprising:
presenting an advertisement matching a keyword contained in a voice query; and
modifying the advertisement based on subscriber identity of a user submitting the voice query as determined by a human searcher.

21. A computer readable storage controlling a computer having a data structure comprising:
an advertisement including:
a location identifier;
a telephone number;
a query; and
a result.
